(19) United States
(12) Patent Application Publication
(10) Pub. No.: US 2013/0342315 A1
(43) Pub. Date: Dec. 26, 2013

(54) SYSTEM AND METHOD FOR MANUALLY PUSHING REMINDERS ON PENDING EVENTS

(71) Applicant: Life of Two, San Francisco, CA (US)

(72) Inventor: Tyson Verstraete, San Francisco, CA (US)

(21) Appl. No.: 13/912,015

(22) Filed: Jun. 6, 2013

Related U.S. Application Data
(60) Provisional application No. 61/656,364, filed on Jun. 6, 2012.

(51) Int. Cl. G08B 5/00

(52) U.S. Cl. CPC G08B 5/00
USPC 340/7.51

(57) ABSTRACT

A system and method that allows a user to push a reminder message on a pending event is provided. As more applications are allowing for timed events to be exchanged between users the ability to force a reminder to be sent on timed events is described. The system provides a manual action for the user to push the reminder whenever they feel it is necessary and as often as they feel it is necessary.

### CROSS REFERENCE TO RELATED APPLICATIONS

This application claims the benefit of U.S. provisional application No. 61/656,364, filed on Jun. 6, 2012, which is expressly incorporated by reference herein in its entirety.

### TECHNICAL FIELD

The present technology pertains to electronic reminders and more specifically pertains to sending of reminders associated with mutally shared data.

### BACKGROUND

In our highly complex world software applications of all types are using timed events to help people track their busy lives. The oldest and most common of these applications is the electronic calendar. This application is built on the concept of appointments, reminders and keeping track of all day-to-day activities. Also common are using timed events within a todo list, grocery list and within vertical applications like Facebook™ for example.

With all these applications and the exchanged data items discussed above the application itself automatically manages the reminder. In most cases a reminder timeframe is sent with the original data item. For example the most common timeframe is to automatically remind the participants of an event 15 minutes before the start time. Most applications allow a customizing of the 15 minute timeframe. In some rare cases the user might be able to set two or more automatic reminders. A common example of when normal reminder fails is when a regularly schedule appointment changes slightly. For example a weekly meeting location has moved from building 2 to building 15, which requires 20 additional minutes to reach. Even the originator of the meeting has forgotten this change until an hour before the meeting and it is then when they need to force an additional reminder.

However this old style of reminder fails to meet the flexibility required in a complex world. What commonly happens is that I know a specific participant is always late for meetings, so I want to send them multiple reminders. I could do this by sending an email message or another form of electronic message not directly associated to the application but this is cumbersome and annoying. I am also forced to construct the message from scratch, think of careful polite wording and hope they are not offended. It would be ideal if such a message could be auto-constructed at the user's command and sent via text, electronic mail or whatever communication means are available. There are other cases where I wish to track information in a way where control over reminders would be very handy. For example if my neighbor borrows my wheelbarrow or some money I might want to remind that person after a month that it would be nice to have the item returned. Therefore be it resolved a solution is still required to improve the ability to manually send reminders to others that share a context between them.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media to address these concerns a manual action is provided within an application to push a reminder to one or more people that share a common information context. The common information context could be a shared calendar appointment between two or more people, an agreed grocery list or a borrowed item between a requestor and a lender. When data items with established deadlines are exchanged or agreed to between two or more people this application provides a method to sending additional reminder notices over a data network. The manual action within the application causes a reminder notice to be pushed using a known data communication method over a data network. When two people share a context, for example they are married then they might be using a shared application for a married couple. In this case the known communication method could be email, personal identification number (PIN), phone number, Facebook™ name or some other well understood method. In some embodiments the application might try several different communication methods to ensure the reminder message is received successfully, based on not receiving back a failure notice.

When there is an established reminder method used by an application, this reminder notice is treated similar to automatically generated reminder notices. This additional reminder method is not meant to replace the existing automatic reminder it is intended to complement it. When there is no established reminder method used by an application then a manually requested, automatically generated message might be sent using any data communication method available as discussed above. Since the reminder notices appears to be connected to the application (i.e. Calendar Reminder, Todo Reminder, Borrow List Reminder, etc) it is less invasive and appears not to be connected to the originator. This creates less tension and bad feelings and ideally reduces the perception that the receiving is tardy and fails to manage their time correctly.

The term data item is used to refer to a wide range of possible information including: shared calendar events, meetings, appointments, todo actions or personal lists like grocery list. Other non-conventional applications that are not associated to reminders could also be enabled using the push to reminder technique. For example adding reminder button to an application could allow an auto-generated reminder message to be requested by the user at any time. Data items could refer to more vertical application data like financial transactions, stock trade orders, GANTT chart task trackers, a borrowed-item tracker and similar specific problem solving applications. For example a borrowed-item tracker might allow the user to track who borrows items from them including their email address or phone number or some combination thereof. Then when the borrow length gets too long they simply push a reminder and an email or SMS text message is sent to them reminding them of the outstanding item borrowed. If the email fails the application then tries SMS, if SMS fails perhaps it tries the Facebook™ account.

The term data network refers to one or more of the current wired and wireless networks available today. Data can be exchanged of a wireless network like LTE, to a wired network like the Internet, and then back to another wireless network like EDGE. The term manual step could involve the use of a button on the screen, a gesture like a swipe of the hand on a touch-screen computer or some other action performed manually by the user. The user performing the manual action may also be able to select specific participants to receive the additional reminder notice.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is an illustration of an exemplary day view calendar screen showing a day of appointments and allowing for the ability to perform manual reminders;

FIG. 2 is an illustration of an exemplary appointment view calendar screen showing another method for sending multiple manual reminders;

FIG. 3 is an illustration of an exemplary list view calendar screen showing another embodiment for sending manual reminders;

FIG. 4 is an illustration of an exemplary Todo task list showing another embodiment for sending manual reminders;

FIG. 5 is a simplified data flow diagram showing the exemplary steps for performing a manual request and delivery of manually generated reminders; and

FIGS. 6A and 6B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

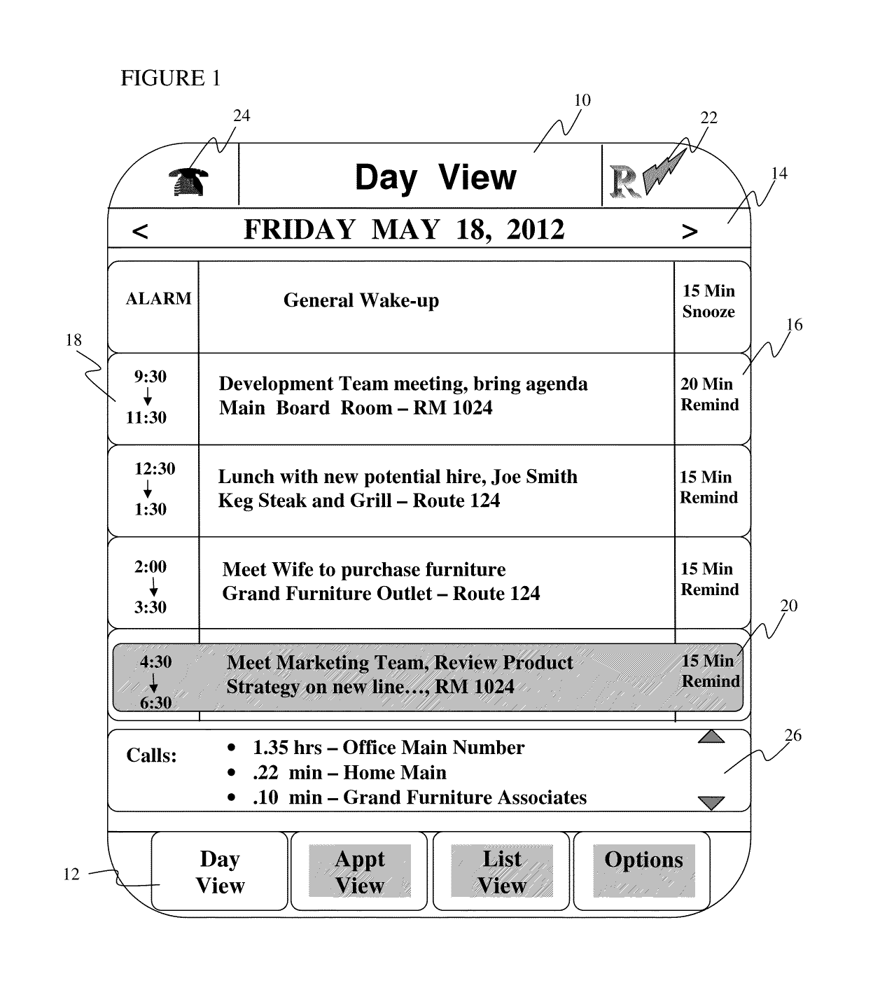

Turning to FIG. 1 there is an illustration of an exemplary day view 12 calendar screen 10 showing a day of appointments and allowing for the ability to perform manual reminders. In this simplified calendar screen the title 10 shows which view is currently opened, the day and date 14 is also illustrated near the top to assist the user. In the corners there are additional icons 24, 22 to perform specialized actions. For illustration purposes the telephone icon 24 can be selected to show the calls that have taken place that day 26.

In FIG. 1 the user can cursor up and down the screen to highlight different appointments. The appointment at 9:30 to 11:30 18 is currently not highlighted and has a planned automatic reminder (16) 20 minutes before the meeting time. Further down the 4:30 to 6:30 appointment is highlighted 20 and has a default reminder of 15 minutes set.

When selected the user has the ability to select the Reminder Icon 22, shown in the top right hand corner. By selecting this icon a manually generated reminder notice will be sent to the participants of the 4:30 meeting 20. In some embodiments there could be an additional prompt ‘Sending Reminder, Yes or No’, to ensure the button wasn't pressed by mistake. Even if the user decides to push an additional reminder notice the defaulted 15 minute reminder will still be seen by that user.

In FIG. 1 the user does not have to open the appointment in order to send an additional reminder notice. If they want to send a reminder to selected people then the additional step of opening the appointment is necessary in FIG. 1. However with advanced user interface (UI) methods it would be simple to prompt the user to select those participants to remind again.

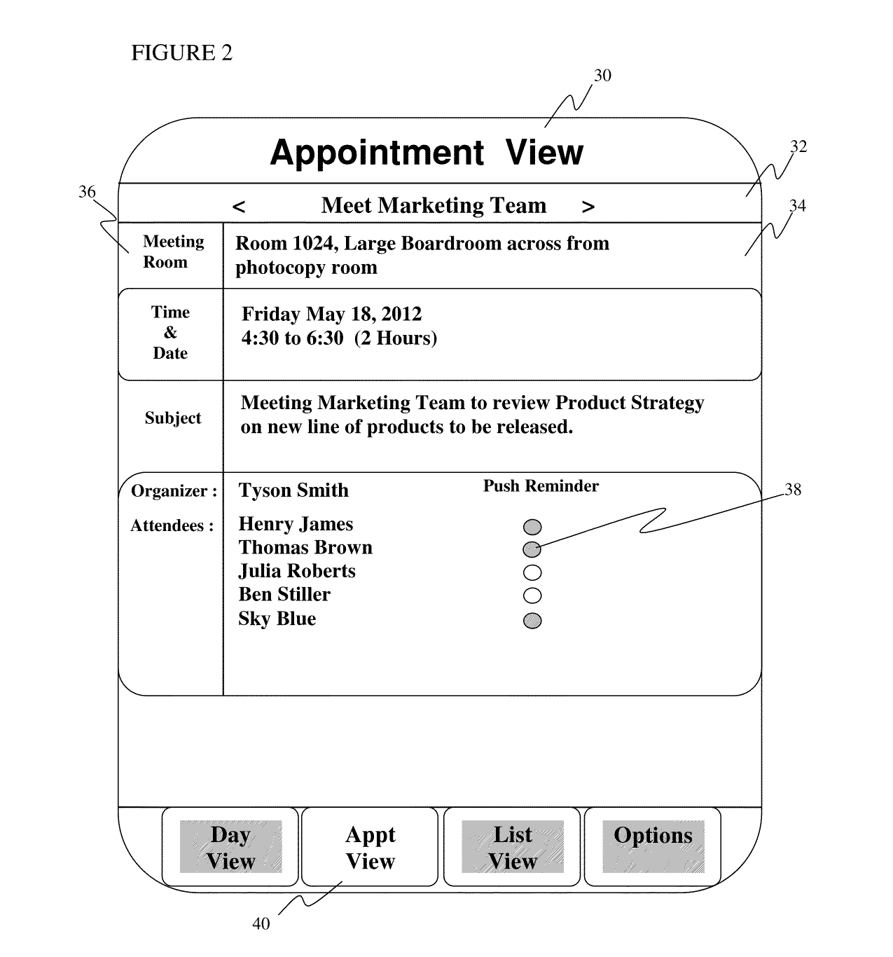

Turning now to FIG. 2 there is an illustration of an exemplary appointment view 40 calendar screen 30 showing another method for sending multiple manual reminders. In this simplified appointment screen 30 there is a title 32 taken from a part of the subject of the appointment. The title is followed by a list of elements 36, like meeting rooms, time & date, etc accompanied by detailed descriptions 34. These details show the exact information entered by the creator for this appointment. Near the bottom is the organizer and attendees of the meeting. In this field are buttons 38 allowing the user to select which specific attendees should receive additional reminders. By selecting the button and exiting this screen a reminder will be send immediate to those selected people.

To one skilled in the art there are many other UI methods that could be used to enhance this screen. In other embodiment it would be easy to add a ‘send reminder now’ action. This screen could be touch-based and by touching a name it could be highlighted to indicate a reminder should be sent. In another embodiment the simple step of opening the appointment view could automatically send a manually generated reminder to all participants.

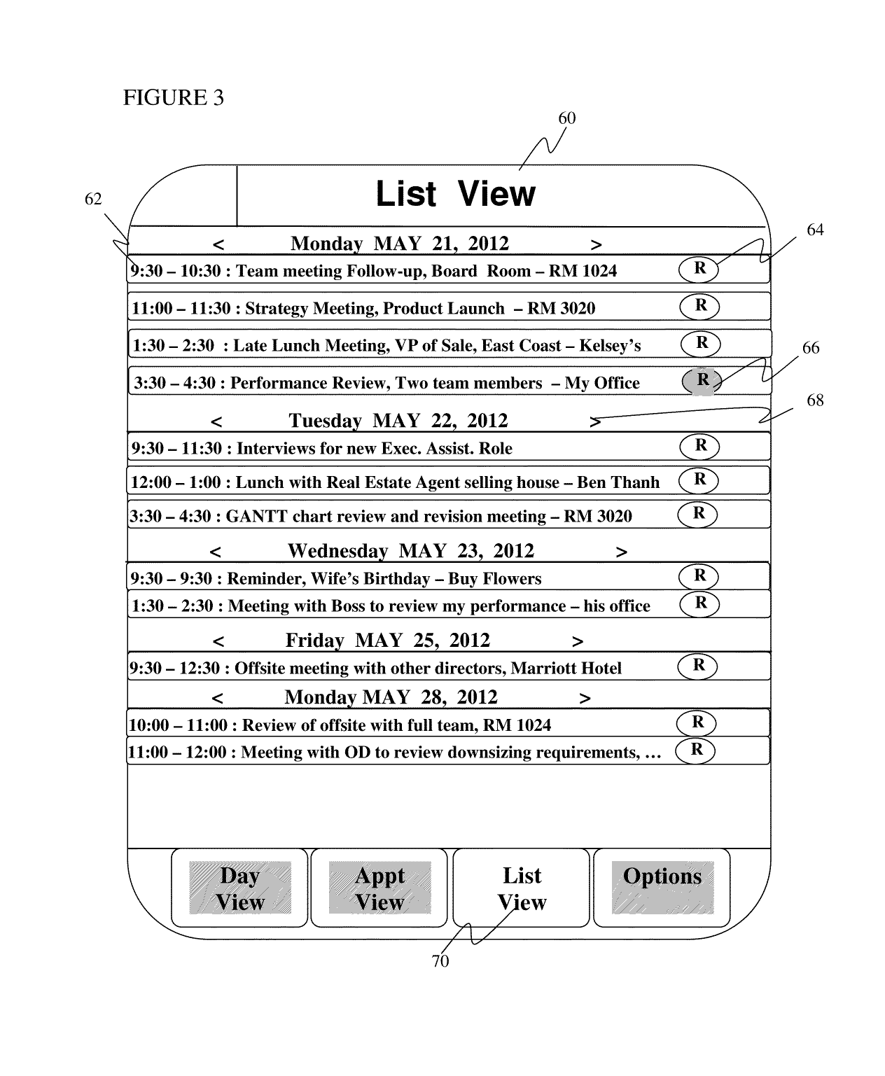

Turning now to FIG. 3 there is an illustration of an exemplary list view 70 calendar screen 60 showing an embodiment for sending manual reminders. In this embodiment a sequential list of all appointments is shown spanning days, weeks even months 68. Each line shows a short summary of an appointment 62 followed by a button with an ‘R’ inside 64. By selecting the ‘R’ button 66 a pushed reminder will be sent to attendees of that appointment. Depending on the UI and the overall effect desired, the user might be prompted before the reminder is sent. Alternatively the user might have to exit this screen before any reminders are sent; this would allow them to select several buttons at the same time before exiting.

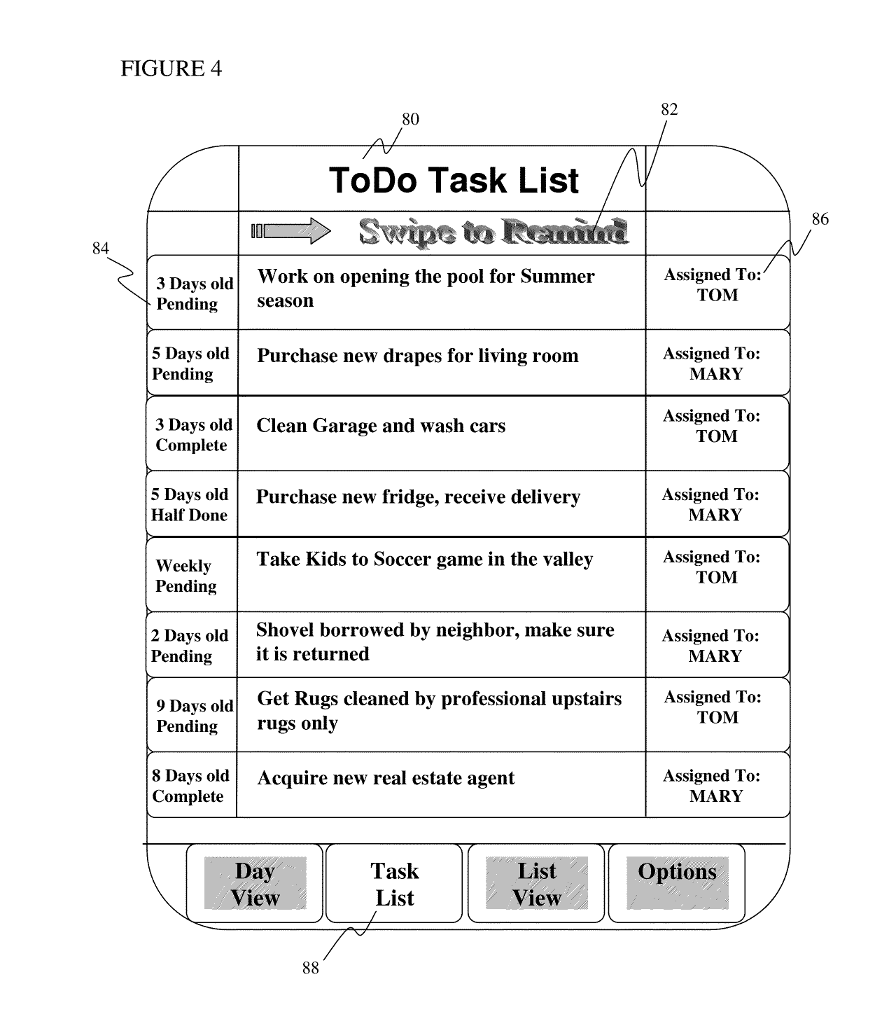

Turning now to FIG. 4 there is an illustration of an exemplary Todo task list 80 showing another embodiment for sending manual reminders. The Todo task list selection button 88 could represent many other applications. Such applications include a grocery list view, a stock purchasing list view, a loan list view or other such time sensitive applications. In this embodiment each time an item is added to the Todo List the user might also be required to enter a corresponding name or identifier to provide context to the Todo item. An application could also automatically search and assign the corresponding name or identifier by leveraging available databases such as address book, email inboxes and social networks. This identifier could be a name, an email address, phone number, Facebook™ name, Twitter™ account or some well know addressing method.

In this simplified UI the user is shown very visually that they can swipe the screen to send a reminder 82. For one skilled in the art such a display would not be necessary for illustration purposes it is useful. In this example each task has an age associated to it including a completion status 84, a detailed description and who the task is assigned to 86. Although this is difficult to illustrate the user simply has to swipe a specific task assignment and a manually generated reminder notice will be sent to the corresponding address of the person associated to that task. If the task should happen to be owned by the person doing the swiping, then it could be handled in two ways. The software could ignore the swipe and treat it like a mistake of the hand. Alternatively the software might be programmed to allow the user to send reminders to themselves. If the software is programmed to prompt the user each and every time before it sends a reminder then the decision as to whether to send a reminder or not is moved into the user's hands.

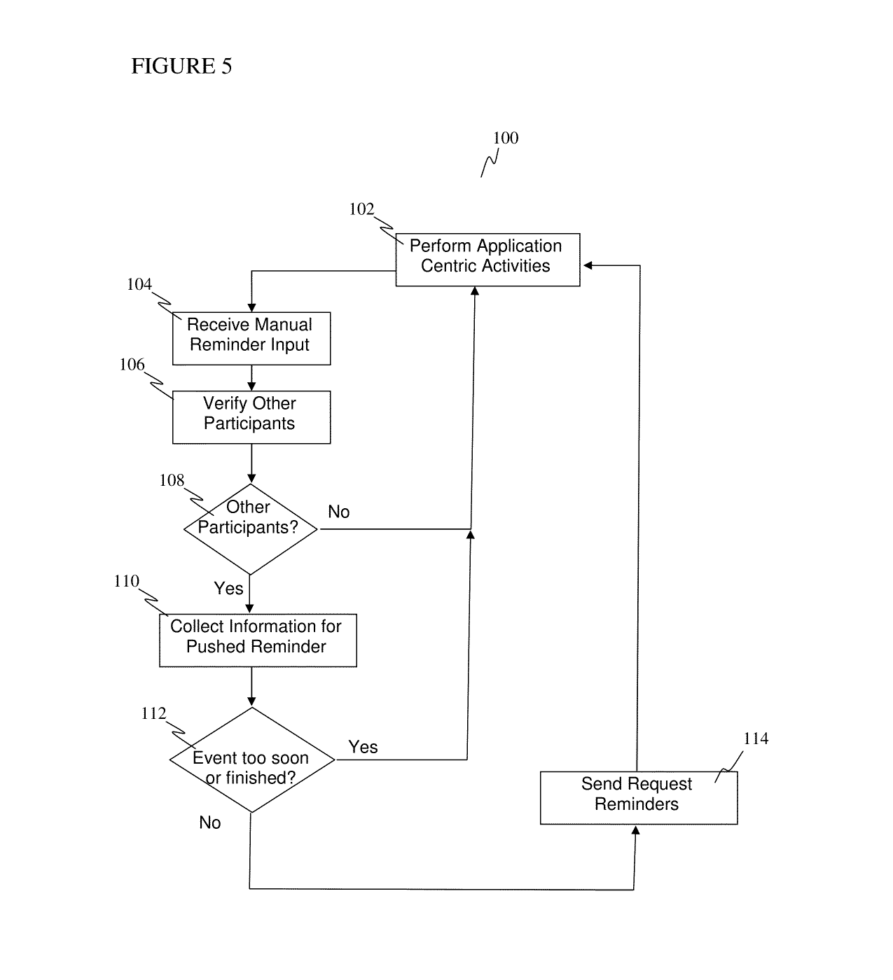

Turning to FIG. 5 there is a simplified data flow diagram 100 showing the exemplary steps for performing a manual request and delivery of manually generated reminders. Within the application being used all normal activities are performed 102. At some point during normal usage the user can perform a manual reminder requested action 104. This action could be touching a button, swiping the screen or selecting a menu. In this embodiment the software first verifies the other participants 106. This might verify that a communication method exists for them, i.e. a phone number, email address, Facebook account or some data communication path can be used to send the reminder. After verifying the state of the other participants a check is performed to see if any participants are left to send a reminder to 108. If there are no participants remaining then the request is ignored and the software returns to perform normal activities 102. Otherwise the software proceeds to collect necessary information about the participants and the activity 110. In this step it verifies the activity, builds a message based on the type of events, and also performs a final check to ensure the event hasn't already finished or is too close to finishing 112. If the event is complete or seconds from completion 112 then the request is ignored and the software returns to perform normal activities 102. Otherwise the requested reminder notice is sent to the designed people 114.

For one skilled in the art there could be additional verification steps used and additional steps added for the reminder construction, but these changes would not affect the overall action of the software.

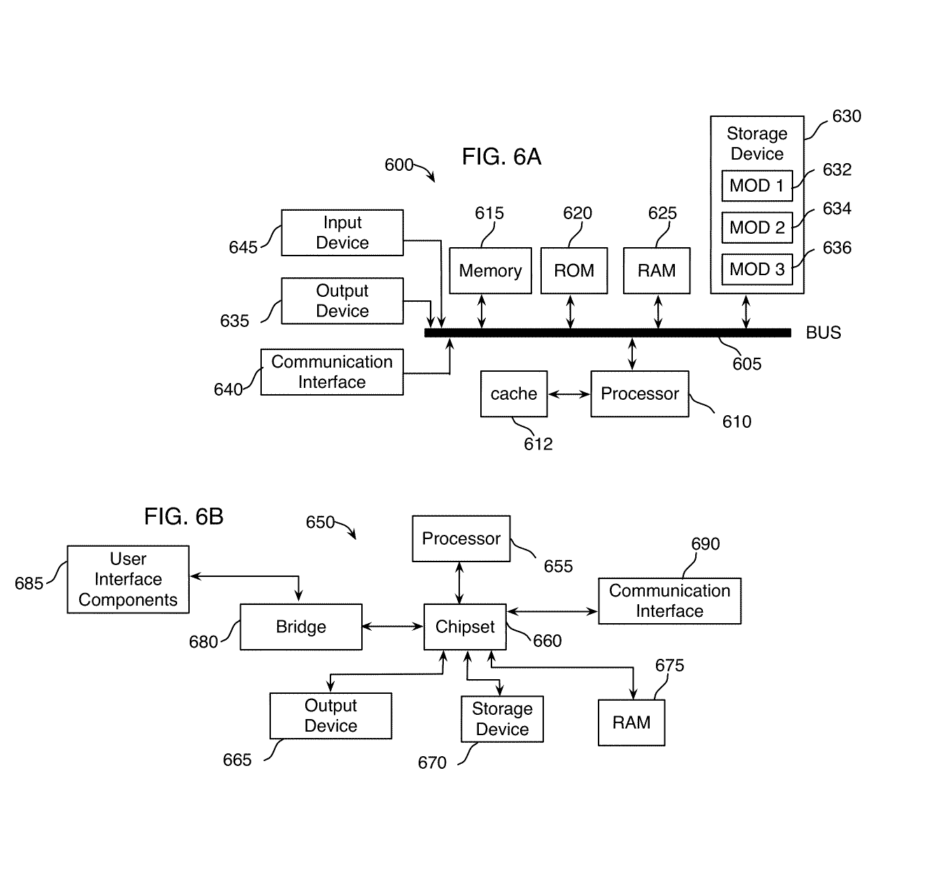

FIG. 6A, and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A system and method for manually pushing auto-generated reminders messages to one or more people that have a shared information context comprised of:
a) creating a data item related to one or more people that share an information context and associating an address identifier to the data item;
b) enabling within an application an input method to request a reminder message be sent to the one or more people that share an information context;
c) automatically generating a reminder message within the application related to the created data item;
d) sending the automatically generated reminder message to the one or more people that share an information context, such that
i) the application attempts to send the reminder message over one or more available data communication methods associated to the created data item.

2. A system and method for manually pushing reminders on pending events comprised of:
a) exchanging a shared data item between two or more people over a data network;
b) establishing a deadline associated to the shared data item that is exchanged between the two or more people over the data network;
c) providing a manual step associated to the shared data item that allows any of the two or more people to execute an additional reminder such that;
i) a reminder message regarding the approaching deadline is sent over the data network to the two or more people that received the shared data item immediately upon performing the manual step.

3. A method of claim 1 such that the reminder message can be sent to just a subset of the two or more people that have received the shared data item.

4. A method of claim 1 wherein the process of simply opening a data item causes a reminder message to be sent.

5. A method of claim 1 wherein the reminder can be sent via an electronic mail message.
